(19) United States
(12) Patent Application Publication
(10) Pub. No.: US 2006/0010323 A1
(43) Pub. Date: Jan. 12, 2006

(54) Method for a repository to provide access to a document, and a repository arranged in accordance with the same method

(75) Inventors: Nathaniel G. Martin, Rochester, NY (US); Johannes A. Koomen, Avon, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 10/887,270

(22) Filed: Jul. 7, 2004

(51) Int. Cl. H04L 9/00

(52) U.S. Cl. 713/171

(57) ABSTRACT

A method is provided by which private data are stored in a repository so that the information is inaccessible even to the owner of the repository. The repository facilitates providing access to the information to arbitrary users. The data are protected by being stored in encrypted form, the encryption taking place on the user's system using public key encryption. The data is shared in one of two ways: 1) on each request, by the owner's system decrypting the document and re-encrypting it using the requester's public key; or 2) over a period of time, by sharing a group private key with the requester by encrypting the group private key using the requester's public key. The repository facilitates both methods so that no direct communication between the owner's system and the users' systems is required.

### INCORPORATION BY REFERENCE OF OTHER U.S. PATENTS

The disclosure of the following two (2) U.S. patents are hereby incorporated by reference, verbatim, and with the same effect as though the same disclosures were fully and completely set forth herein:

U.S. Pat. No. 4,200,770, Martin E. Hellman, Bailey W. Diffie and Ralph C. Merkle, “Cryptographic apparatus and method”, issued 29 Apr. 1980; and

U.S. Pat. No. 6,530,020, Ryuichi Aoki, “Group oriented public key encryption and key management system”, issued 4 Mar. 2003, hereinafter referred to as “Aoki” or “the Aoki patent”.

### BACKGROUND OF THE INVENTION

Computer based data management systems such as databases or document repositories allow people to share information. However, most such systems assume that those persons who manage the data have complete access to the data. This assumption is valid when those persons who manage the data also own the data. However, recent trends towards leasing data management capabilities from third parties may make this assumption invalid. Moreover, when third parties manage data, the owner of the data may want to share it with others while at the same time keeping the data private from the data managers.

Accordingly, there is a need for a method of using public key encryption to share data using a data management system without giving access to the data by those managing it.

### BRIEF SUMMARY OF THE INVENTION

In a first aspect of the invention, there is described, in a system comprising a repository, an owner and a reader, the owner having an owner public key and a corresponding owner secret key, the reader having a reader public key and a corresponding reader secret key, the repository having a document encoded with the owner public key, the repository, owner and reader being coupled by a communication means, a method for the repository to provide access to the document to a requester, the requester being the owner or the reader, the method comprising: (a) by the requester, sending a request for the document to the repository, the request including the requester's public key; and (b) by the repository, determining when the requester is the owner and when the requester is the reader.

In a second aspect of the invention, there is described, in a system comprising a repository, an owner and a reader, the owner having an owner public key and a corresponding owner secret key, the reader having a reader public key and a corresponding reader secret key, the repository comprising a document encoded with the owner public key, the repository comprising a list, the list including one or more reader public keys corresponding to readers who are allowed access to the document, the repository further comprising a copy of the document encoded with each reader public key comprised in the list, the repository, owner and reader being coupled by a communication means, a method for the repository to provide access to the document to a requester, the requester being the owner or the reader, the method comprising: (a) by the requester, sending a request for the document to the repository, the request including the requester's public key; and (b) by the repository, determining when the requester is the owner and when the requester is the reader.

In a third aspect of the invention, there is described, in a system comprising a repository, an owner and a reader, the owner having an owner public key and a corresponding owner secret key, the reader having a reader public key and a corresponding reader secret key, the repository comprising a document encoded with the owner public key, the repository comprising a list, the list including one or more reader public keys corresponding to readers who are allowed access to the document, the list further including a copy of the owner secret key encoded with each reader public key comprised in the list, the repository, owner and reader being coupled by a communication means, a method for the repository to provide access to the document to a requester, the requester being the owner or the reader, the method comprising: (a) by the requester, sending a request for the document to the repository, the request including the requester's public key; and (b) by the repository, determining when the requester is the owner and when the requester is the reader.

In a fourth aspect of the invention, there is described a repository arranged to couple to an owner and a reader by means of a communication means, the owner having an owner public key and a corresponding owner secret key, the reader having a reader public key and a corresponding reader secret key, the repository having a document encoded with the owner public key, the repository arranged to provide access to the document to a requester in accordance with a method, the requester being the owner or the reader, the method comprising: (a) receiving, from the requester, a request for the document, the request including the requester's public key; (b) when the request includes the owner public key, determining that the requester is the owner and sending the document encoded with the owner public key to the owner, thus providing the owner with access to the document; (c) when the request includes the reader public key, determining that the requester is the reader and sending the reader public key and the document encoded with the owner public key to the owner; and (d) in response to the owner determining to allow the reader to access the document, receiving, from the owner, the document encoded with the reader public key and sending the document encoded with the reader public key to the reader, thus providing the reader with access to the document.

In a fifth aspect of the invention, there is described a repository arranged to couple to an owner and a reader by means of a communication means, the owner having an owner public key and a corresponding owner secret key, the reader having a reader public key and a corresponding reader secret key, the repository comprising a document encoded with the owner public key, the repository comprising a list, the list including one or more reader public keys corresponding to readers who are allowed access to the document, the repository further comprising a copy of the document encoded with each reader public key comprised in the list, the repository arranged to provide access to the document to a requester in accordance with a method, the requester being the owner or the reader, the method comprising: (a) receiving, from the requester, a request for the document, the request including the requester's public key; (b) when the request includes the owner public key, determining that the requester is the owner and sending the document encoded with the owner public key to the owner, thus providing the owner with access to the document; (c) when the request includes the reader public key, determining that the requester is the reader and determining when the reader public key is comprised in the list; (d) when the reader public key is comprised in the list and, accordingly, the repository includes a copy of the document encoded with the reader public key, sending the copy of the document encoded with the reader public key to the reader, thus providing the reader with access to the document; (e) when the reader public key is not comprised in the list, sending the reader public key and the document encoded with the owner public key to the owner; and (f) in response to the owner determining to allow the reader to access the document, receiving, from the owner, the document encoded with the reader public key; adding the reader public key to the list and storing the document encoded with the reader public key; and sending the document encoded with the reader public key to the reader, thus providing the reader with access to the document.

In a sixth aspect of the invention, there is described a repository arranged to couple to an owner and a reader by means of a communication means, the owner having an owner public key and a corresponding owner secret key, the reader having a reader public key and a corresponding reader secret key, the repository comprising a document encoded with the owner public key, the repository comprising a list, the list including one or more reader public keys corresponding to readers who are allowed access to the document, the list further including a copy of the owner secret key encoded with each reader public key comprised in the list, the repository, the repository arranged to provide access to the document to a requester in accordance with a method, the requester being the owner or the reader, the method comprising: (a) receiving, from the requester, a request for the document, the request including the requester's public key; (b) when the request includes the owner public key, determining that the requester is the owner and sending the document encoded with the owner public key to the owner, thus providing the owner with access to the document; (c) when the request includes the reader public key, determining that the requester is the reader and determining when the reader public key is comprised in the list; (d) when the reader public key is comprised in the list and, accordingly, the list includes a copy of the owner secret key encoded with the reader public key, sending the owner secret key encoded with the reader public key and the document encoded with the owner public key to the reader, thus providing the reader with access to the document; (e) when the reader public key is not comprised in the list, sending the reader public key and the document encoded with the owner public key to the owner; and (f) in response to the owner determining to allow the reader to access the document, receiving, from the owner, the owner secret key encoded with the reader public key; adding the reader public key and the owner secret key encoded with the reader public key to the list; and sending the owner secret key encoded with the reader public key and the document encoded with the owner public key to the reader, thus providing the reader with access to the document.

### BRIEF DESCRIPTION OF THE SEVERAL VIEWS OF THE DRAWING

FIG. 1 depicts a system 100 that may be used to demonstrate a first embodiment 200 of a method for a repository to provide access to a document, in accordance with the present invention.

As shown in FIG. 1, the system 100 comprises a repository 110, an owner 120 and a reader 130. The owner 120 has an owner public key (P1) and a corresponding owner secret key (S1). The reader 130 has a reader public key (P2) and a corresponding reader secret key (S2). The repository 110 comprises a document 101 encoded with the owner public key (P1). The repository, owner and reader are coupled by a communication means 140.

FIG. 2 depicts a flow diagram for the first embodiment 200.

FIG. 3 depicts a system 300 that may be used to demonstrate a second embodiment 400 of a method for a repository to provide access to a document, in accordance with the present invention.

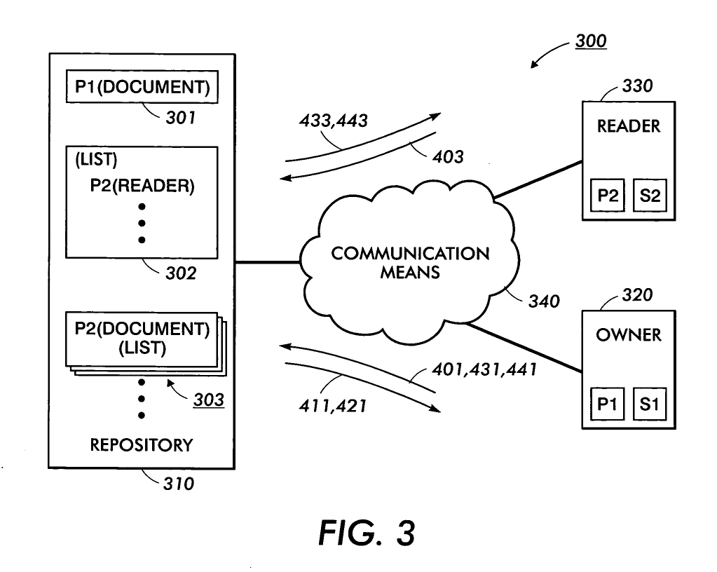

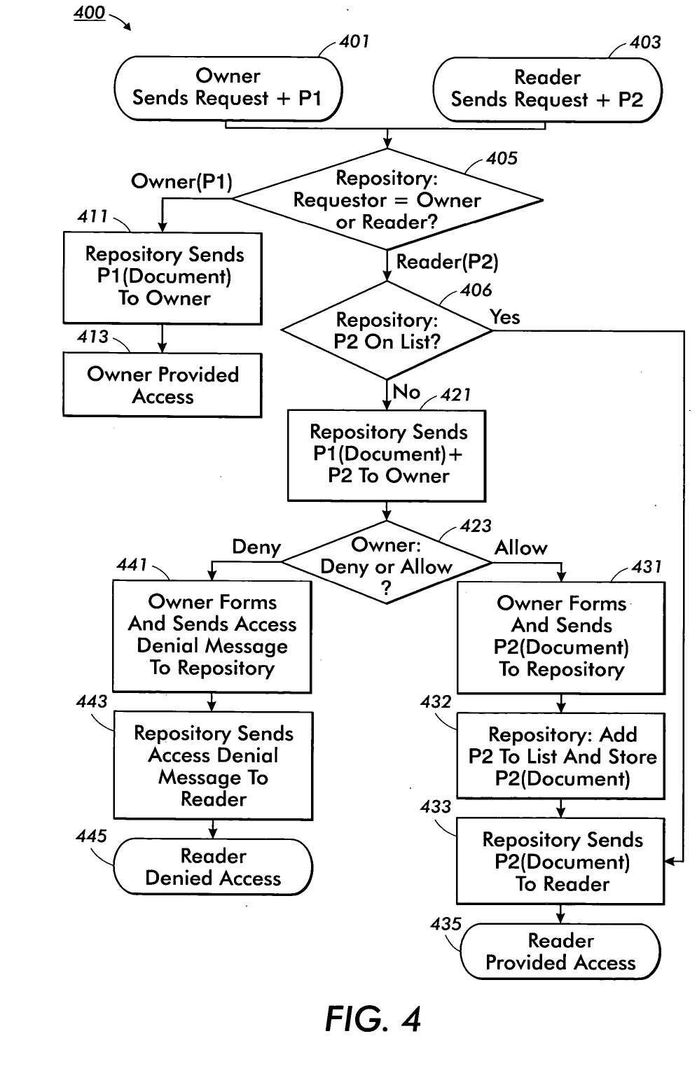

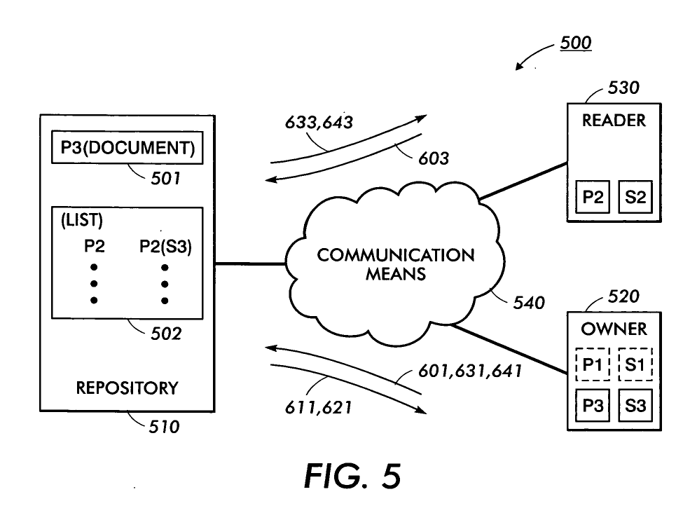

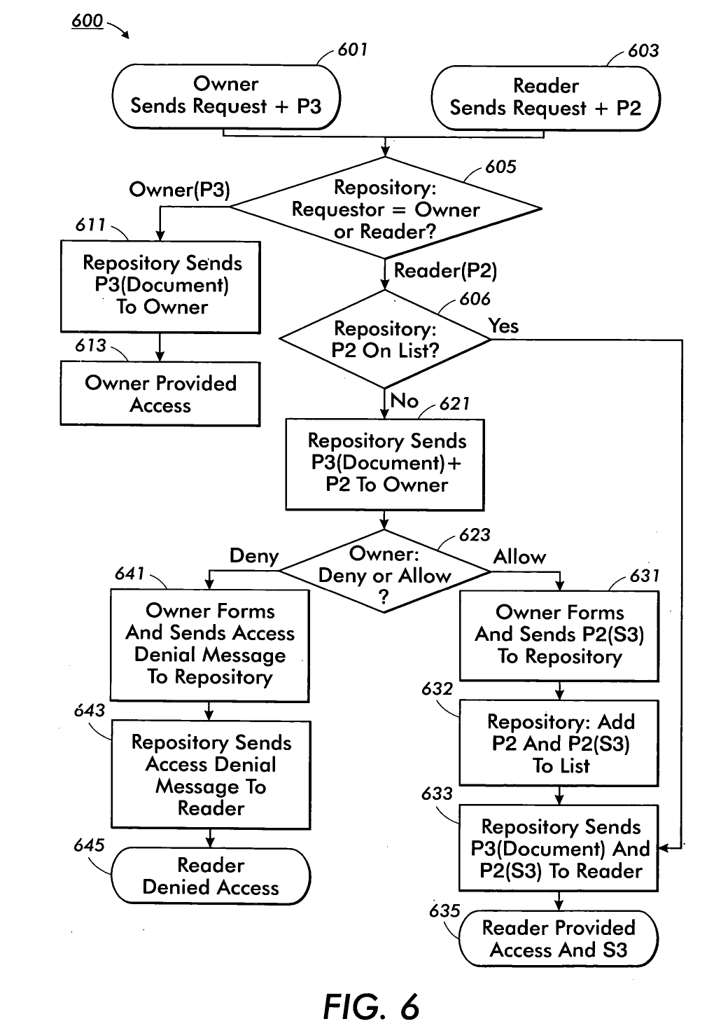

As shown in FIG. 3, the system 300 comprises a repository 310, an owner 320 and a reader 330. The owner 320 has an owner public key (P1) and a corresponding owner secret key (S1). The reader 330 has a reader public key (P2) and a corresponding reader secret key (S2). The repository 310 comprises a document 301 encoded with the owner public key (P1). The repository 310 comprises a list 302. The list 302 includes one or more reader public keys (P2's) corresponding to readers who are allowed access to the document 301. The repository 310 further comprises a copy 303 of the document encoded with each reader public key (P2) comprised in the list 302. The repository, owner and reader are coupled by a communication means 340.

FIG. 4 depicts a flow diagram for the second embodiment 400.

FIG. 5 depicts a system 300 that may be used to demonstrate a third embodiment 600 of a method for a repository to provide access to a document, in accordance with the present invention.

As shown in FIG. 5, the system 500 comprises a repository 510, an owner 520 and a reader 530. The owner 520 has an owner public key (P3) and a corresponding owner secret key (S3). The reader 530 has a reader public key (P2) and a corresponding reader secret key (S2). The repository 510 comprises a document 501 encoded with the owner public key (P3). The repository 510 comprises a list 502. The list 502 includes one or more reader public keys (P2's) corresponding to readers who are allowed access to the document 501. The list 502 further includes a copy of the owner secret key (S3) encoded with each reader public key comprised in the list 502. The repository, owner and reader are coupled by a communication means 540.

FIG. 6 depicts a flow diagram for the third embodiment 600.

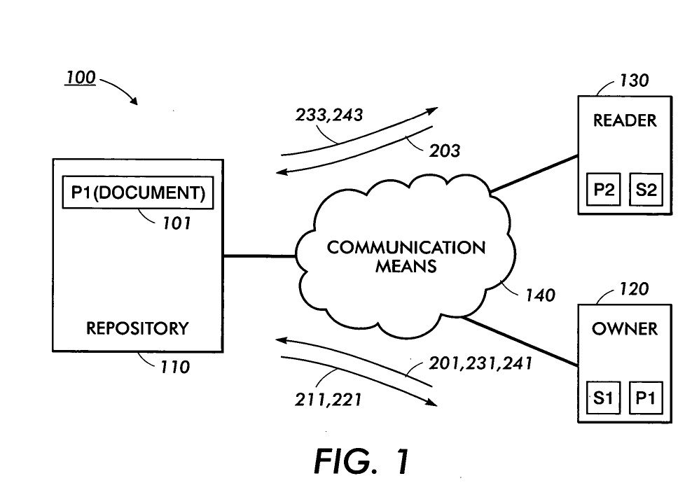

Referring generally to FIGS. 1-6, it will be understood by those skilled in the art that data encrypted with any depicted public key can only be decrypted with the corresponding secret key and data encrypted with any depicted secret key can only be decrypted with the corresponding public key. Thus, data encrypted with the owner public key (P1) can only be decrypted with the owner secret key (S1) and data encrypted with the owner secret key (S1) can only be decrypted with the owner public key (P1). Further, data encrypted with the owner public key (P3) can only be decrypted with the owner secret key (S3) and data encrypted with the owner secret key (S3) can only be decrypted with the owner public key (P3). Also, data encrypted with the reader public key (P2) can only be decrypted with the reader secret key (S2) and data encrypted with the reader secret key (S2) can only be decrypted with the reader public key (P2).

### DETAILED DESCRIPTION OF THE INVENTION

Briefly, a method is provided by which private data are stored in a repository so that the information is inaccessible even to the owner of the repository. The repository facilitates providing access to the information to arbitrary users. The data are protected by being stored in encrypted form, the encryption taking place on the user's system using public key encryption. The data is shared in one of two ways: 1) on each request, by the owner's system decrypting the document and re-encrypting it using the requester's public key; or 2) over a period of time, by sharing a group private key with the requester by encrypting the group private key using the requester's public key. The repository facilitates both methods so that no direct communication between the owner's system and the users' systems is required.

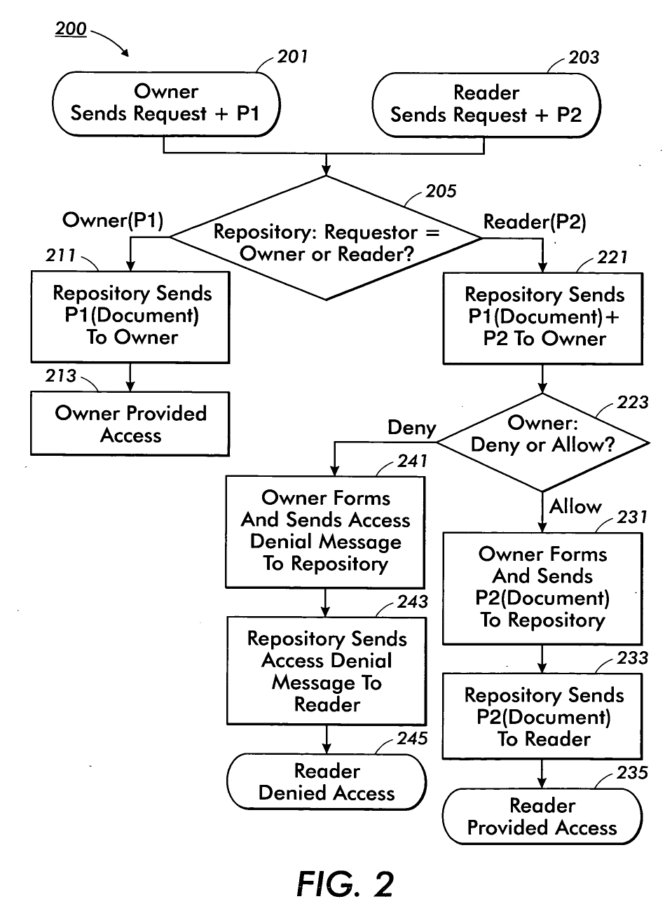

Referring now to FIG. 1 there is shown a system 100 comprising a repository 110, an owner 120 and a reader 130, the owner having an owner public key (P1) and a corresponding owner secret key (S1), the reader having a reader public key (P2) and a corresponding reader secret key (S2), the repository having a document 101 encoded with the owner public key (P1), the repository, owner and reader being coupled by a communication means 140. The repository 110 is arranged to provide access to the document to a requester, the requester being the owner or the reader, in accordance with a method 200 that is depicted in FIG. 2.

Referring now to FIG. 2, in steps 201 and 203, the requester, that is, the owner (step 201) or the reader (step 203), sends a request for the document 101 to the repository, the request including the requester's public key. For good understanding, the requester's public key is P1 when the requester is the owner and the requester's public key is P2 when the requester is the reader. The process then goes to step 205.

In step 205, the repository determines when the requester is the owner and when the requester is the reader. The repository determines that the requester is the owner when the request includes the owner public key (P1), and the repository determines that the requester is the reader when the request includes the reader public key (P2).

Still referring to step 205, when the repository determines that the requester is the owner, the process next goes to step 211, where the repository sends the document 101 encoded with the owner public key (P1) to the owner, thus providing (step 213) the owner with access to the document.

Returning to step 205, when the repository determines that the requester is the reader, the process next goes to step 221, where the repository sends the reader public key (P2) and the document 101 encoded with the owner public key (P1) to the owner. The process then goes to step 223.

In step 223, the owner determines when to allow the reader to access the document 101.

Still referring to step 223, when the owner determines to allow the reader to access the document 101, the owner forms (step 231) the document 101 encoded with the reader public key (P2) and sends (step 231) the document encoded with the reader public key (P2) to the repository. The process then goes to step 233.

In step 233, the repository sends the document 101 encoded with the reader public key (P2) to the reader, thus providing the reader with access (step 235) to the document.

Returning to step 223, when the owner determines to not allow the reader to access the document 101, the owner forms (step 241) an access denial message and sends (step 241) the access denial message to the repository. The process then goes to step 243.

In step 243, the repository sends (step 243) the access denial message to the reader, thus denying (step 245) the reader access to the document.

Referring now to FIG. 3, there is shown a system 300 comprising a repository 310, an owner 320 and a reader 330, the owner 320 having an owner public key (P1) and a corresponding owner secret key (S1), the reader 330 having a reader public key (P2) and a corresponding reader secret key (S2), the repository 310 comprising a document 301 encoded with the owner public key (P1), the repository 310 comprising a list 302, the list 302 including one or more reader public keys (P2's) corresponding to readers who are allowed access to the document 301, the repository 310 further comprising a copy 303 of the document encoded with each reader public key (P2) comprised in the list 302, the repository, owner and reader being coupled by a communication means 340. The repository is arranged to provide access to the document to a requester, the requester being the owner or the reader, in accordance with a method 400 that is depicted in FIG. 4.

Referring now to FIG. 4, in steps 401 and 403, the requester, that is, the owner (step 401) or the reader (step 403), sends a request for the document 301 to the repository, the request including the requester's public key. For good understanding, the requester's public key is P1 when the requester is the owner and the requester's public key is P2 when the requester is the reader. The process then goes to step 405.

In step 405, the repository determines when the requester is the owner and when the requester is the reader. The repository determines that the requester is the owner when the request includes the owner public key (P1), and the repository determines that the requester is the reader when the request includes the reader public key (P2).

Still referring to step 405, when the repository determines that the requester is the owner, the process next goes to step 411, where the repository sends the document 301 encoded with the owner public key (P1) to the owner, thus providing (step 413) the owner with access to the document.

Returning to step 405, when the repository determines that the requester is the reader, the process then goes to step 406, where the repository determines when the reader public key (P2) is comprised in the list.

Referring to step 406, when the repository determines that the reader public key (P2) is comprised in the list and, accordingly, that the repository includes a copy of the document encoded with the reader public key (P2), the process goes to step 433, where the repository sends the copy of the document encoded with the reader public key (P2) to the reader, thus providing (step 435) the reader with access to the document.

Returning to step 406, when the repository determines that the reader public key (P2) is not comprised in the list, the process goes to step 421, where the repository sends the reader public key (P2) and the document 301 encoded with the owner public key (P1) to the owner. The process then goes to step 423.

In step 423, the owner determines when to allow the reader to access the document 301.

Still referring to step 423, when the owner determines to allow the reader to access the document 301, the owner forms (step 431) the document 301 encoded with the reader public key (P2) and sends (step 431) the document encoded with the reader public key (P2) to the repository. The process then goes to step 432.

In step 432, the repository adds the reader public key (P2) to the list 302 and stores the document 301 encoded with the reader public key (P2). The process then goes to step 433.

In step 433, the repository sends the document 301 encoded with the reader public key (P2) to the reader, thus providing (step 435) the reader with access to the document.

Returning to step 423, when the owner determines to not allow the reader to access the document 301, the owner forms (step 441) an access denial message and sends the access denial message to the repository. The process then goes to step 443.

In step 443, the repository sends the access denial message to the reader, thus denying (step 445) the reader access to the document.

Referring now to FIG. 5, there is shown a system 500 comprising a repository 510, an owner 520 and a reader 530, the owner 520 having an owner public key (P3) and a corresponding owner secret key (S3), the reader 530 having a reader public key (P2) and a corresponding reader secret key (S2), the repository 510 comprising a document 501 encoded with the owner public key (P3), the repository 510 comprising a list 502, the list 502 including one or more reader public keys (P2's) corresponding to readers who are allowed access to the document 501, the list 502 further including a copy of the owner secret key (S3) encoded with each reader public key comprised in the list 502, the repository, owner and reader being coupled by a communication means 540. The repository 510 is arranged to provide access to the document to a requester, the requester being the owner or the reader, in accordance with a method 600 that is depicted in FIG. 6.

Referring now to FIG. 6, in steps 601 and 603, the requester, that is, the owner (step 601) or the reader (step 603), sends a request for the document 501 to the repository, the request including the requester's public key. For good understanding, the requester's public key is P1 when the requester is the owner and the requester's public key is P2 when the requester is the reader. The process then goes to step 605.

In step 605, the repository determines when the requester is the owner and when the requester is the reader. The repository determines that the requester is the owner when the request includes the owner public key (P1), and the repository determines that the requester is the reader when the request includes the reader public key (P2).

Still referring to step 605, when the repository determines that the requester is the owner, the process next goes to step 611, where the repository sends the document 301 encoded with the owner public key (P1) to the owner, thus providing (step 613) the owner with access to the document.

Returning to step 605, when the repository determines that the requester is the reader, the process then goes to step 606, where the repository determines when the reader public key (P2) is comprised in the list.

Referring to step 606, when the repository determines that the reader public key (P2) is comprised in the list and, accordingly, that the list includes a copy of the owner secret key (S3) encoded with the reader public key (P2), the process goes to step 622, where the repository sends the owner secret key (S3) encoded with the reader public key (P2) and the document 501 encoded with the owner public key (P3) to the reader, thus providing (step 635) the reader with access to the document.

Returning to step 606, when the repository determines that the reader public key (P2) is not comprised in the list, the process goes to step 621, where the repository sends the reader public key (P2) and the document 501 encoded with the owner public key (P3) to the owner. The process then goes to step 623.

In step 623, the owner determines when to allow the reader to access the document 501. When the owner determines to allow the reader to access the document 501, the owner forms (step 631) the owner secret key (S3) encoded with the reader public key (P2) and sends (step 631) the owner secret key (S3) encoded with the reader public key (P2) to the repository. The process then goes to step 632.

In step 632, the repository adds the reader public key (P2) and the owner secret key (S3) encoded with the reader public key (P2) to the list 502. The process then goes to step 633.

In step 633, the repository sends the owner secret key (S3) encoded with the reader public key (P2) and the document 501 encoded with the owner public key (P3) to the reader, thus providing (step 635) the reader with access to the document.

Returning to step 623, when the owner determines to not allow the reader to access the document 501, the owner forms (step 641) an access denial message and sends the access denial message to the repository. The process then goes to step 643.

In step 643, the repository sends the access denial message to the reader, thus denying (step 645) the reader access to the document.

As is known, encryption is a common way to keep private data private. Public key encryption uses a pair of keys, on kept secret and one disclosed publicly with the property that data encrypted with the secret key can only be decrypted using the public key and data encrypted with the public key can only be decrypted using the secret key. Public key encryption supports sharing private information without disclosing it inadvertently by allowing the owner of the information to encrypt it with the public key of the person the owner wants to share it with, the reader. If the reader has kept the secret key private, only the reader can decrypt the data.

The present invention provides a system for sharing data through a shared data management system using public key encryption. The system works by encrypting the owner's data with the public keys of the readers, with whom the owner wants to share the data. The system provides a mechanism for a reader to request data from the owner and for the owner to give access to the information to the data stored in the data management system without giving access to the managers of the system.

To do this, readers provide their public key whenever the request data from the repository indicating that they have the secret key to decrypt the data. We describe three embodiments of the invention.

In the first embodiment depicted in FIGS. 1-2, the data management system forwards the encrypted version of the requested document to the owner of that document. If the owner wishes to give access to the document to the reader, the owner encrypts the requested document with the reader's public key and returns it to the data management system, which forwards the newly encrypted document to the reader.

In the second embodiment depicted in FIGS. 3-4, the data management system also stores the newly encrypted document along with the reader's public key. In this way, the system can respond to subsequent requests by same reader without contacting the owner.

In the third embodiment depicted in FIGS. 5-6, the document is encrypted with a special secret key that is unique to the group of readers who share access to the document with the owner. In this case, the data management system maintains a list of this secret key encrypted with each reader's public key. In this embodiment, the system responds to subsequent requests for the document with the document encrypted with the group's secret key and the group's secret key encrypted with the individual reader's public key.

In all those embodiments depicted in FIGS. 1-6, each user of the system has a program, called the client, through which he or she accesses the repository. The client manages public key encryption so the user is not burdened with additional complexity. The client allows the user to store encrypted documents in the repository and share encrypted documents with other users of the repository.

If the user wishes to share information with other users of the repository, this sharing can occur in multiple ways. Two types of access to the document are described below:

First, “dependent access”, which corresponds to the first embodiment depicted in FIGS. 1-2, wherein a reader requests access from an owner each time the reader wants the document; and

Second, “independent access”, which corresponds to the second and third embodiments respectively depicted in FIGS. 3-4 and 5-6 wherein the owner of the document gives a reader the ability to access the document without asking permission each time.

In the first embodiment of FIGS. 1-2, to access the document in a dependent manner, a reader sends (step 203) the repository a request including its public key. The repository forwards (step 221) the request to the owner. In step 231, the owner authenticates the reader by any convenient means, such as, for example, by using a digital signature, retrieves the document decrypting it using its secret key, re-encrypts it using the reader's public key, and returns it to the repository to be forwarded to the reader. Each time the reader wants to retrieve the document from the database, this sequence repeats.

In the second embodiment of FIGS. 3-4 and the third embodiment of FIGS. 5-6, the owner can grant a reader independent access to a document in two ways, as follows:

First, the owner can encrypt the document using the reader's public key each time it stores the document; and

Second, the owner can create a new group key that it shares with the reader.

In the second embodiment of FIGS. 3-4, granting independent access to a document is supported by the owner keeping a copy of the readers' public keys and encrypting the document with each of these public keys and storing all of these encrypted files each time the owner stores the document. The reader can then access the instance of the document that was encrypted with its public key at will; it need not contact the owner again to gain access.

In the third embodiment of FIGS. 5-6, when the owner grants independent access by creating a new group key, it retrieves and decrypts the document, re-encrypts it with the new group public key, then sends it to the repository to replace the version encrypted with the owner's public key. A reader requests the encrypted document and decrypts it with the group secret key; the reader need not request access from the owner.

The ability to change the contents of the repository and access to the repository, such as removing access to a document, should be limited. The public key encryption system used by the clients provides a convenient way for the repository to authenticate them. Each request to the repository is accompanied by a digital signature that the repository uses to authenticate the client. The configuration management mechanisms set up by the repository can use this information to ensure that only authorized users can modify the repository. The signature is assumed in each of the calls detailed below.

For all three embodiments of FIGS. 1-6, to store a document, an owner of the document issues a “store” command to the repository providing as parameters the owner's public key, the document to be stored encrypted with the owner's public key, the name for the document, and the owner's address, e.g., Store(DocName,Ao,Po,Po(Doc)). On receipt of this command, the repository stores the encrypted document, the name, the owner's public key, and the owner's address.

For all three embodiments of FIGS. 1-6, the following section describes document retrieval by the owner.

To retrieve the document, the reader sends the document name, and the reader's public key, corresponding to step 203 (first embodiment), step 403 (second embodiment) and step 603 (third embodiment). The repository first checks to see if the reader and the owner are the same by comparing the reader's public key with the document's public key. If the reader and the owner are the same, it returns the public key associated with the document and the encrypted document.

First, the owner stores the document encrypted with a public key for which it has a secret key, a copy public key and its address. Second, the same client, now in the reader's role, send a request containing: the document's name and the public key that the document was encrypted with, e.g., Request(DocName,Ar,Pr)), step 203 (first embodiment), step 403 (second embodiment), step 603 (third embodiment). Because the public key in the request, Pr, matches the public key stored with the document, Po, the repository returns the encrypted document Po(Doc) and the public key that encrypted the document, Po, e.g., Retrieved(DocName,Po,Po(Doc)), step 211, step 411, step 611. This correspondence between public and secret keys is maintained by the client, a program, so the user need only request the document, he or she need not remember the relationship between public and secret keys.

The document reader (here, also the document owner) uses the public key that the repository has returned as an index into its key ring to retrieve the secret key that will decrypt the document, step 213 (first embodiment), step 413 (second embodiment), step 613 (third embodiment). The reader/owner needs multiple keys, and therefore an index into its key ring, because the owner will have document encrypted with different keys in the same database to share access to the document independently.

Referring now to FIGS. 1-2, the first embodiment is now discussed. As discussed in greater detail below, the first embodiment is characterized by dependent document sharing.

When sharing a document dependently, the reader requests the document from the repository, step 203. Then, the repository notifies the owner that a document has been requested, step 211. The owner decrypts the document, re-encrypts the document with the reader's public key, and returns the re-encrypted document to the repository who returns it to the reader, step 231.

The reader requests the document just as if it had permission to read the document (i.e. Request(DocName,Ar,Pr)), step 203. The repository receives this request and checks the public key against the public key associated with this record, step 205. It sees that the public key associated with the record, the owner's public key, does not match the public key in this request so it forwards the request to the owner including the document and the public key that was used to encrypt the document (i.e. Requested(DocName,Ar,Pr,Po,Po(Doc))), step 221. The owner uses the first public key, to look up the secret key it has stored on its key ring. It uses that secret key to decrypt the document and uses the second public key in the request, the reader's public key, to re-encrypt the document, step 231. It passes the re-encrypted document back to the Repository (i.e., Granted(DocName,Ar,Pr,Pr(Doc))), step 231. The repository knows that this should be forwarded on to the reader because it contains the reader's address so it sends the request, step 233. (Since the owner has the address, the owner could forward the reply to the reader directly. The advantage of the owner forwarding the response to the reader is that the repository need not be involved again. The advantage of the repository forwarding the response back to the reader is that the reader need not be aware that it does not have direct access to the document.)

The advantage of the dependent method is that the owner of the document is always in control of the document. The reader is not even aware that the owner was involved in retrieving the document, it returns just as if the reader had rights to the document. The owner can track all access to the document.

The disadvantage of the dependent method is that both the reader and the owner have to be available to enable the sharing. Since the owner is a client program, this is possible, but access to the data now relies on two programs doubling the chance of access failure.

Referring now to FIGS. 3-6, the second and third embodiments are now discussed. As discussed in greater detail below, the second and third embodiments are characterized by independent document sharing.

Independent document sharing avoids the requirement that the owner be on line for a reader to access its documents. There are three ways to do this.

The first way is documented in the foregoing Aoki patent. In Aoki, a group lock is created for the document and passed around with the document. To use in a repository, the locked document would be stored and the repository would not be given access.

In accordance with the present invention, the second and third embodiments assume that all communication between clients occurs with through the repository.

Referring now to FIG. 3, the second embodiment is now discussed. The second embodiment is similar to the first embodiment's dependent method as depicted in FIGS. 1-2, differing in that the repository maintains a buffer for requests for encrypted documents, 302, and for the encrypted documents themselves when they are returned, 303.

Referring now to FIG. 5, the third embodiment is now discussed. The third embodiment maintains an access control list that stores a group key—i.e. a key associated with the document that is shared by the group—encrypted using the public key of each of the clients who have access to the document, 502. The list of group keys could also be stored by the clients, as well as the repository.

Further to the third embodiment, the advantage of the storing the group key on the repository over storing the group key in the clients, is that it is simpler to remove access to the document; its disadvantage is that it requires a double decryption each time the document is downloaded.

The advantage of the storing the key in the client over storing the key in the client, is that access to the document is usually the same whether a client is an owner or not; its disadvantage is the removing access requires an extra step.

Returning again to FIGS. 3-4, the second embodiment is now further discussed. As described in greater detail below, this second embodiment is characterized by access without shared keys.

In the second embodiment, to share access without sharing keys, the owner and the reader make asynchronous calls through the repository. First, the reader places a request for the document on the Access Control List ACL request list with the command Request(DocName,Ar,Pr), step 403.

Second, the repository realizes that the reader is not the owner and that the owner is not available to receive a dependent request. The repository acknowledges the request and the reader goes off line, step 405.

When the owner comes back on line, the repository forwards the readers request to the owner. The owner decrypts the document and re-encrypts it using the reader's public key. Then, the owner responds to the repository with the command, ACLAddDoc(DocName,Ar,Pr,Pr(Doc)), step 421. The owner goes off line, and the repository stores the re-encrypted document on the ACL.

When the reader comes back on line, the repository returns the document in the way it would have had the reader made a dependent request, Retrieved(DocName,Pr,Pr(Doc)), step 433.

The second embodiment for implementing shared access is most appropriate when clients are usually connected to the repository interacting dependently. This extends the dependent method to cover the cases where a client is unavailable when a request is made.

Also, unless the client maintains a separate copy of the group secret key, the owner can request that the repository manage access to the document. For example, the owner could request that the repository allow a limited number of accesses to the reader and then delete the encrypted document. Or the owner could request that the repository only allow access to the document for a certain amount of time. If this option is chosen, some of the mechanism of managing access is delegated to the repository, but the repository still does not have access to the contents of the documents it manages. Because some of the mechanism is supplied by the repository, a certain degree of trust is required.

Requesting that the repository manage the document requires more storage on the repository because the repository will need to store a document for each reader or group that has access to the document.

Returning again to FIGS. 5-6, the third embodiment is now further discussed. As described in greater detail below, this third embodiment is characterized by access through keys shared on the repository.

In the third embodiment, clients must be able to handle multiple keys because secret keys give a reader access to all documents that were encrypted with that key. The owner must be able to create new key pairs to use as group keys to allow change in the members of a group sharing a document. The keys need to be shared through the repository because there is no guarantee that the clients will be on line at the same time. Since the repository is not trusted, the owner of the document encrypts the group secret key with the reader's public key. With this encryption, the owner is assured that the only the reader can access the secret key and therefore the document.

Still referring to the third embodiment of FIGS. 5-6, the following section describes setting up the ACL.

If the owner wants to give continual access, it creates a new group public/secret key pair (Pg, Sg) and encrypts its Sg key with the reader's public key and returns it to the repository using the ACL command, ACLAddKey(DocName,Ar,Pr,Pr(Sg)). When the repository receives this response, it puts a record consisting of the reader's address, the reader's public key, and the group's secret key encrypted with the reader's public key (i.e. Ar, Pr and Pr(Sg)) on the ACL (502) of the document called DocName, 501.

The reader requests a document that it does not own, but that it does have independent access to. That is, the reader has been added to the ACL.

If the reader's key is in the ACL (step 606) the repository responds with RetrievedWithKey(DocName, Pg, Pg(Doc), Pr, Pr(Sg)) without contacting the owner, step 633. The reader decrypts the group's secret key using its secret key and then uses the group's secret key to decrypt the document.

The following section describes adding a reader to the ACL.

The reader requests a document that it does not have access rights to. The repository sees that the owner is not on line and stores the information the owner will need to give access to the client.

First, the reader requests a document from the repository using the usual request: Request(DocName, Ar, Pr), step 603. The repository sees that the reader's public key does not match the owner's public key of the document with the name “DocName” and the owner of the document is not on line, so it places the reader's public key and address on the list of requests for the document, step 606. The repository sends an acknowledgement to the reader.

When the owner of the document comes on line the repository forwards the reader's request, Requested(DocName,Ar,Pr,Po,Po(Doc)), step 621. This is the same request that it would get for a dependent request. The owner then decides whether to give the reader continual access to the document or only give it one time access, step 623. If the owner decides to grant independent access, it responds with an ACL command to the repository, step 631. Now, when the repository gets the ACLAddKey request, it puts the reader on the ACL (step 632) and forwards a document to the reader using the command RetrievedWithKey(DocName,Pg,Pg(Doc),Pr,PR(Sg)), step 632. The reader can now decrypt the document for its user. It also knows that it has independent access.

The following section describes retracting access to a reader on the ACL.

When independent access to a document needs to be retracted, the data must be re-encrypted with a new key, because the system cannot guarantee that the deleted member has destroyed the previous key. When the owner wants to remove access from a reader (say, for example, the reader is represented by the symbol “r7”) in the repository, it first creates a new pair of public and secret keys (Pg2and Sg2 respectively), re-encrypts the document, then sends the repository the command Remove-ACL(DocName,Pr7,Pg2,Pg2(Doc)). When the repository receives this command, it removes all records from its ACL and puts all readers except reader r7 in the ACL requests list. The same steps described earlier will then cause the repository to ask the owner for and receive the new secret group key encrypted with each reader's public key. Now, when any of the readers request the document using their own public key, they receive the reply RetrievedWithKey(DocName,Pg2,Pg2(Doc),Pr,Pr(Sg2)). However, when r7 requests the document, r7's public key will not appear in the ACL-Request list, so its request will be forwarded to the owner (who will presumably deny it).

Referring again generally to FIGS. 1-6, in one embodiment, any of the communication means 140, 340 and 540 comprises any of an internet, a telecommunication network and a wireless communication network.

In summary, there has been described the first aspect of the invention, namely, in a system 100 comprising a repository 110, an owner 120 and a reader 130, the owner having an owner public key (P1) and a corresponding owner secret key (S1), the reader having a reader public key (P2) and a corresponding reader secret key (S2), the repository having a document 101 encoded with the owner public key (P1), the repository, owner and reader being coupled by a communication means 140, a method 200 for the repository to provide access to the document to a requester, the requester being the owner or the reader, the method 200 comprising: (a) by the requester, sending (step 201 or 203) a request for the document 101 to the repository, the request including the requester's public key (P1 or P2); and (b) by the repository, determining (step 205) when the requester is the owner and when the requester is the reader.

Also, there has been described the second aspect of the invention, namely, in a system 300 comprising a repository 310, an owner 320 and a reader 330, the owner 320 having an owner public key (P1) and a corresponding owner secret key (S1), the reader 330 having a reader public key (P2) and a corresponding reader secret key (S2), the repository 310 comprising a document 301 encoded with the owner public key (P1), the repository 310 comprising a list 302, the list 302 including one or more reader public keys (P2's) corresponding to readers who are allowed access to the document 301, the repository 310 further comprising a copy 303 of the document encoded with each reader public key (P2) comprised in the list 302, the repository, owner and reader being coupled by a communication means 340, a method 400 for the repository to provide access to the document to a requester, the requester being the owner or the reader, the method 400 comprising: (a) by the requester, sending (step 401 or 403) a request for the document 301 to the repository, the request including the requester's public key (P1 or P2); and (b) by the repository, determining (step 405) when the requester is the owner and when the requester is the reader.

Also, there has been described the third aspect of the invention, namely, in a system 500 comprising a repository 510, an owner 520 and a reader 530, the owner 520 having an owner public key (P3) and a corresponding owner secret key (S3), the reader 530 having a reader public key (P2) and a corresponding reader secret key (S2), the repository 510 comprising a document 501 encoded with the owner public key (P3), the repository 510 comprising a list 502, the list 502 including one or more reader public keys (P2's) corresponding to readers who are allowed access to the document 501, the list 502 further including a copy of the owner secret key (S3) encoded with each reader public key comprised in the list 502, the repository, owner and reader being coupled by a communication means 540, a method 600 for the repository to provide access to the document to a requester, the requester being the owner or the reader, the method 600 comprising: (a) by the requester, sending (step 601 or 603) a request for the document 501 to the repository, the request including the requester's public key (P3 or P2); and (b) by the repository, determining (step 605) when the requester is the owner and when the requester is the reader.

Also, there has been described the fourth aspect of the invention, namely, a repository 110 arranged to couple to an owner 120 and a reader 130 by means of a communication means 140, the owner having an owner public key (P1) and a corresponding owner secret key (S1), the reader having a reader public key (P2) and a corresponding reader secret key (S2), the repository having a document 101 encoded with the owner public key (P1), the repository arranged to provide access to the document to a requester in accordance with a method 200, the requester being the owner or the reader, the method 200 comprising: (a) receiving (step 201 or 203), from the requester, a request for the document 101, the request including the requester's public key (P1 or P2); (b) when the request includes the owner public key (P1), determining (step 205) that the requester is the owner and sending (step 211) the document 101 encoded with the owner public key (P1) to the owner, thus providing (step 213) the owner with access to the document; (c) when the request includes the reader public key (P2), determining (step 205) that the requester is the reader and sending (step 221) the reader public key (P2) and the document 101 encoded with the owner public key (P1) to the owner; and (d) in response to the owner determining to allow the reader to access the document 101, receiving (step 231), from the owner, the document 101 encoded with the reader public key (P2) and sending (step 233) the document 101 encoded with the reader public key (P2) to the reader, thus providing the reader with access (step 235) to the document.

Also, there has been described the fifth aspect of the invention, namely, a repository 310 arranged to couple to an-owner 320 and a reader 330 by means of a communication means 340, the owner 320 having an owner public key (P1) and a corresponding owner secret key (S1), the reader 330 having a reader public key (P2) and a corresponding reader secret key (S2), the repository 310 comprising a document 301 encoded with the owner public key (P1), the repository 310 comprising a list 302, the list 302 including one or more reader public keys (P2's) corresponding to readers who are allowed access to the document 301, the repository 310 further comprising a copy 303 of the document encoded with each reader public key (P2) comprised in the list 302, the repository arranged to provide access to the document to a requester in accordance with a method 400, the requester being the owner or the reader, the method 400 comprising: (a) receiving (step 401 or 403), from the requester, a request for the document 301, the request including the requester's public key (P1 or P2); (b) when the request includes the owner public key (P1), determining (step 405) that the requester is the owner and sending (step 411) the document 301 encoded with the owner public key (P1) to the owner, thus providing (step 413) the owner with access to the document; (c) when the request includes the reader public key (P2), determining that the requester is the reader and determining (step 406) when the reader public key (P2) is comprised in the list; (d) when the reader public key (P2) is comprised in the list and, accordingly, the repository includes a copy of the document encoded with the reader public key (P2), sending (step 433) the copy of the document encoded with the reader public key (P2) to the reader, thus providing (step 435) the reader with access to the document; (e) when the reader public key (P2) is not comprised in the list, sending (step 421) the reader public key (P2) and the document 301 encoded with the owner public key (P1) to the owner; and (f) in response to the owner determining to allow the reader to access the document 301, receiving (step 431), from the owner, the document encoded with the reader public key (P2); adding (step 432) the reader public key (P2) to the list 302 and storing (step 432) the document 301 encoded with the reader public key (P2); and sending (step 433) the document 301 encoded with the reader public key (P2) to the reader, thus providing (step 435) the reader with access to the document.

Also, there has been described the sixth aspect of the invention, namely, a repository 510 arranged to couple to an owner 520 and a reader 530 by means of a communication means 540, the owner 520 having an owner public key (P3) and a corresponding owner secret key (S3), the reader 530 having a reader public key (P2) and a corresponding reader secret key (S2), the repository 510 comprising a document 501 encoded with the owner public key (P3), the repository 510 comprising a list 502, the list 502 including one or more reader public keys (P2's) corresponding to readers who are allowed access to the document 501, the list 502 further including a copy of the owner secret key (S3) encoded with each reader public key comprised in the list 502, the repository, the repository arranged to provide access to the document to a requester in accordance with a method 600, the requester being the owner or the reader, the method 600 comprising: (a) receiving (step 601 or 603), from the requester, a request for the document 501, the request including the requester's public key (P3 or P2); (b) when the request includes the owner public key (P3), determining (step 605) that the requester is the owner and sending (step 611) the document 501 encoded with the owner public key (P3) to the owner, thus providing (step 613) the owner with access to the document; (c) when the request includes the reader public key (P2), determining that the requester is the reader and determining (step 606) when the reader public key (P2) is comprised in the list; (d) when the reader public key (P2) is comprised in the list and, accordingly, the list includes a copy of the owner secret key (S3) encoded with the reader public key (P2), sending (step 633) the owner secret key (S3) encoded with the reader public key (P2) and the document 501 encoded with the owner public key (P3) to the reader, thus providing (step 635) the reader with access to the document; (e) when the reader public key (P2) is not comprised in the list, sending (step 621) the reader public key (P2) and the document 501 encoded with the owner public key (P3) to the owner; and (f) in response to the owner determining to allow the reader to access the document 501, receiving (step 631), from the owner, the owner secret key (S3) encoded with the reader public key (P2); adding (step 632) the reader public key (P2) and the owner secret key (S3) encoded with the reader public key (P2) to the list 502; and sending (step 633) the owner secret key (S3) encoded with the reader public key (P2) and the document 501 encoded with the owner public key (P3) to the reader, thus providing (step 635) the reader with access to the document.

While various embodiments of a method for a repository to provide access to a document, and a repository arranged in accordance with the same method, in accordance with the present invention, have been described hereinabove, the scope of the invention is defined by the following claims.

What is claimed is:

1. In a system comprising a repository, an owner and a reader, the owner having an owner public key and a corresponding owner secret key, the reader having a reader public key and a corresponding reader secret key, the repository having a document encoded with the owner public key, the repository, owner and reader being coupled by a communication means, a method for the repository to provide access to the document to a requester, the requester being the owner or the reader, the method comprising:
(a) by the requester, sending a request for the document to the repository, the request including the requester's public key; and
(b) by the repository, determining when the requester is the owner and when the requester is the reader.

2. The method of claim 1, the repository determining that the requester is the owner when the request includes the owner public key.

3. The method of claim 2 including, by the repository, when it is determined that the requester is the owner, sending the document encoded with the owner public key to the owner, thus providing the owner with access to the document.

4. The method of claim 1, the repository determining that the requester is the reader when the request includes the reader public key.

5. The method of claim 4 including, by the repository, when it is determined that the requester is the reader, sending the reader public key and the document encoded with the owner public key to the owner.

6. The method of claim 5 including, by the owner, determining when to allow the reader to access the document.

7. The method of claim 6 including, by the owner, when it is determined to allow the reader to access the document, forming the document encoded with the reader public key and sending the document encoded with the reader public key to the repository.

8. The method of claim 7 including, by the repository, sending the document encoded with the reader public key to the reader, thus providing the reader with access to the document.

9. The method of claim 6 including, by the owner, when it is determined to not allow the reader to access the document, forming an access denial message and sending the access denial message to the repository.

10. The method of claim 9 including, by the repository, sending the access denial message to the reader, thus denying the reader access to the document.

11. In a system comprising a repository, an owner and a reader, the owner having an owner public key and a corresponding owner secret key, the reader having a reader public key and a corresponding reader secret key, the repository comprising a document encoded with the owner public key, the repository comprising a list, the list including one or more reader public keys corresponding to readers who are allowed access to the document, the repository further comprising a copy of the document encoded with each reader public key comprised in the list, the repository, owner and reader being coupled by a communication means, a method for the repository to provide access to the document to a requester, the requester being the owner or the reader, the method comprising:
(a) by the requester, sending a request for the document to the repository, the request including the requester's public key; and
(b) by the repository, determining when the requester is the owner and when the requester is the reader.

12. The method of claim 11, the repository determining that the requester is the owner when the request includes the owner public key.

13. The method of claim 12 including, by the repository, when it is determined that the requester is the owner, sending the document encoded with the owner public key to the owner, thus providing the owner with access to the document.

14. The method of claim 11, the repository determining that the requester is the reader when the request includes the reader public key.

15. The method of claim 14 including, by the repository, determining when the reader public key is comprised in the list.

16. The method of claim 15 including, by the repository, when it is determined that the reader public key is comprised in the list and, accordingly, that the repository includes a copy of the document encoded with the reader public key, sending the copy of the document encoded with the reader public key to the reader, thus providing the reader with access to the document.

17. The method of claim 15 including, by the repository, when it is determined that the reader public key is not comprised in the list, sending the reader public key and the document encoded with the owner public key to the owner.

18. The method of claim 17 including, by the owner, determining when to allow the reader to access the document.

19. The method of claim 18 including, by the owner, when it is determined to allow the reader to access the document, forming the document encoded with the reader public key and sending the document encoded with the reader public key to the repository.

20. The method of claim 19 including, by the repository, adding the reader public key to the list and storing the document encoded with the reader public key.

21. The method of claim 20 including, by the repository, sending the document encoded with the reader public key to the reader, thus providing the reader with access to the document.

22. The method of claim 18 including, by the owner, when it is determined to not allow the reader to access the document, forming an access denial message and sending the access denial message to the repository.

23. The method of claim 22 including, by the repository, sending the access denial message to the reader, thus denying the reader access to the document.

24. In a system comprising a repository, an owner and a reader, the owner having an owner public key and a corresponding owner secret key, the reader having a reader public key and a corresponding reader secret key, the repository comprising a document encoded with the owner public key, the repository comprising a list, the list including one or more reader public keys corresponding to readers who are allowed access to the document, the list further including a copy of the owner secret key encoded with each reader public key comprised in the list, the repository, owner and reader being coupled by a communication means, a method for the repository to provide access to the document to a requester, the requester being the owner or the reader, the method comprising:
(a) by the requester, sending a request for the document to the repository, the request including the requester's public key; and
(b) by the repository, determining when the requester is the owner and when the requester is the reader.

25. The method of claim 24, the repository determining that the requester is the owner when the request includes the owner public key.

26. The method of claim 25 including, by the repository, when it is determined that the requester is the owner, sending the document encoded with the owner public key to the owner, thus providing the owner with access to the document.

27. The method of claim 24, the repository determining that the requester is the reader when the request includes the reader public key.

28. The method of claim 27 including, by the repository, determining when the reader public key is comprised in the list.

29. The method of claim 28 including, by the repository, when it is determined that the reader public key is comprised in the list and, accordingly, that the list includes a copy of the owner secret key encoded with the reader public key, sending the owner secret key encoded with the reader public key and the document encoded with the owner public key to the reader, thus providing the reader with access to the document.

30. The method of claim 28 including, by the repository, when it is determined that the reader public key is not comprised in the list, sending the reader public key and the document encoded with the owner public key to the owner.

31. The method of claim 30 including, by the owner, determining when to allow the reader to access the document.

32. The method of claim 31 including, by the owner, when it is determined to allow the reader to access the document, forming the owner secret key encoded with the reader public key and sending the owner secret key encoded with the reader public key to the repository.

33. The method of claim 32 including, by the repository, adding the reader public key and the owner secret key encoded with the reader public key to the list.

34. The method of claim 33 including, by the repository, sending the owner secret key encoded with the reader public key and the document encoded with the owner public key to the reader, thus providing the reader with access to the document.

35. The method of claim 31 including, by the owner, when it is determined to not allow the reader to access the document, forming an access denial message and sending the access denial message to the repository.

36. The method of claim 35 including, by the repository, sending the access denial message to the reader, thus denying the reader access to the document.

37. A repository arranged to couple to an owner and a reader by means of a communication means, the owner having an owner public key and a corresponding owner secret key, the reader having a reader public key and a corresponding reader secret key, the repository having a document encoded with the owner public key, the repository arranged to provide access to the document to a requester in accordance with a method, the requester being the owner or the reader, the method comprising:
(a) receiving, from the requester, a request for the document, the request including the requester's public key;
(b) when the request includes the owner public key, determining that the requester is the owner and sending the document encoded with the owner public key to the owner, thus providing the owner with access to the document;
(c) when the request includes the reader public key, determining that the requester is the reader and sending the reader public key and the document encoded with the owner public key to the owner; and
(d) in response to the owner determining to allow the reader to access the document, receiving, from the owner, the document encoded with the reader public key and sending the document encoded with the reader public key to the reader, thus providing the reader with access to the document.

38. The repository of claim 37, the method including, in response to the owner determining to not allow the reader to access the document, receiving, from the owner, an access denial message and sending the access denial message to the reader, thus denying the reader access to the document.

39. A repository arranged to couple to an owner and a reader by means of a communication means, the owner having an owner public key and a corresponding owner secret key, the reader having a reader public key and a corresponding reader secret key, the repository comprising a document encoded with the owner public key, the repository comprising a list, the list including one or more reader public keys corresponding to readers who are allowed access to the document, the repository further comprising a copy of the document encoded with each reader public key comprised in the list, the repository arranged to provide access to the document to a requester in accordance with a method, the requester being the owner or the reader, the method comprising:
(a) receiving, from the requester, a request for the document, the request including the requester's public key;
(b) when the request includes the owner public key, determining that the requester is the owner and sending the document encoded with the owner public key to the owner, thus providing the owner with access to the document;
(c) when the request includes the reader public key, determining that the requester is the reader and determining when the reader public key is comprised in the list;
(d) when the reader public key is comprised in the list and, accordingly, the repository includes a copy of the document encoded with the reader public key, sending the copy of the document encoded with the reader public key to the reader, thus providing the reader with access to the document;
(e) when the reader public key is not comprised in the list, sending the reader public key and the document encoded with the owner public key to the owner; and
(f) in response to the owner determining to allow the reader to access the document, receiving, from the owner, the document encoded with the reader public key; adding the reader public key to the list and storing the document encoded with the reader public key; and sending the document encoded with the reader public key to the reader, thus providing the reader with access to the document.

40. The repository of claim 39, the method including, in response to the owner determining to not allow the reader to access the document, receiving, from the owner, an access denial message and sending the access denial message to the reader, thus denying the reader access to the document.

41. A repository arranged to couple to an owner and a reader by means of a communication means, the owner having an owner public key and a corresponding owner secret key, the reader having a reader public key and a corresponding reader secret key, the repository comprising a document encoded with the owner public key, the repository comprising a list, the list including one or more reader public keys corresponding to readers who are allowed access to the document, the list further including a copy of the owner secret key encoded with each reader public key comprised in the list, the repository, the repository arranged to provide access to the document to a requester in accordance with a method, the requester being the owner or the reader, the method comprising:
(a) receiving, from the requester, a request-for the document, the request including the requester's public key;
(b) when the request includes the owner public key, determining that the requester is the owner and sending the document encoded with the owner public key to the owner, thus providing the owner with access to the document;
(c) when the request includes the reader public key, determining that the requester is the reader and determining when the reader public key is comprised in the list;
(d) when the reader public key is comprised in the list and, accordingly, the list includes a copy of the owner secret key encoded with the reader public key, sending the owner secret key encoded with the reader public key and the document encoded with the owner public key to the reader, thus providing the reader with access to the document;
(e) when the reader public key is not comprised in the list, sending the reader public key and the document encoded with the owner public key to the owner; and
(f) in response to the owner determining to allow the reader to access the document, receiving, from the owner, the owner secret key encoded with the reader public key; adding the reader public key and the owner secret key encoded with the reader public key to the list; and sending the owner secret key encoded with the reader public key and the document encoded with the owner public key to the reader, thus providing the reader with access to the document.

42. The repository of claim 41, the method including, in response to the owner determining to not allow the reader to access the document, receiving, from the owner, an access denial message and sending the access denial message to the reader, thus denying the reader access to the document.
